(19) United States
(12) Patent Application Publication
(10) Pub. No.: US 2025/0070209 A1
(43) Pub. Date: Feb. 27, 2025

(54) CO2 CAPTURE SYSTEM FOR FUEL CELL POWER PLANT

(71) Applicant: HYAXIOM, INC., East Hartford, CT (US)

(72) Inventors: Brian Chakulski, Hartford, CT (US); Michael Letterio, Boston, MA (US)

(21) Appl. No.: 18/237,991

(22) Filed: Aug. 25, 2023

(51) Int. Cl. H01M 8/0668; H01M 8/04089; H01M 8/04746; H01M 8/0612

(52) U.S. Cl. CPC H01M 8/0668; H01M 8/04097; H01M 8/04761; H01M 8/0618

(57) ABSTRACT

An illustrative example embodiment of a method and system is provided which includes fueling a reformer in a fuel cell power plant with natural gas and directing an output from the reformer into a CO₂ capture system.

### BACKGROUND

Phosphoric acid fuel cells (PAFC) are a type of fuel cell that uses liquid phosphoric acid as an electrolyte. PAFC power plants can run on natural gas to produce electrical power. Natural gas comprises primarily methane and smaller amounts of higher hydrocarbons, and is reformed to produce a hydrogen rich steam via Steam Methane Reforming (SMR). An output of a reformer is delivered to a Low Temperature Shift Converter (LTSC), where a water-gas shift reaction (WGSR) occurs to form additional hydrogen and convert much of the CO formed in the reformer to carbon dioxide. The SMR reaction is endothermic and requires a heat source to drive the conversion of hydrocarbons to hydrogen. Current configurations of PAFC power plants use approximately 80% of the hydrogen delivered to the PAFCs for the electrochemical reaction that produces electricity, water, and waste heat. The remaining 20% of the hydrogen is delivered back to a burner and combusted with air to produce the heat necessary to drive the reforming reaction.

The output of the burner is thus a stream that comprises of N₂, O₂, H₂O, and CO₂ (the latter of which is a byproduct of SMR/WGSR). Current PAFC power plants tend to mix this stream with cathode exhaust, which is delivered to a condenser to knock out water and phosphoric acid. The outlet of the condenser is typically mixed with ventilation air and forms a power plant exhaust outlet. The combination of condenser exhaust and ventilation air exiting the power plant has typically about 3% CO₂.

Systems for CO₂ capture are used to combat harmful effects of greenhouse gas emissions on climate change. There is significant interest in capturing and storing the CO₂ from any device that uses a fossil fuel such as natural gas, including PAFC power plants. The relatively low volume fraction of CO₂ in the power plant outlet exhaust outlet, e.g. 3% CO₂, makes this capture difficult and costly.

### SUMMARY

An illustrative example embodiment of a method includes: fueling a reformer in a fuel cell power plant with natural gas; and directing an output from the reformer into a CO₂ capture system.

In an embodiment having one or more features of the method of the previous paragraph, the method includes directing the output from the reformer into an anode prior to entering the CO₂ capture system.

In an embodiment having one or more features of the method of any of the previous paragraphs, the method includes directing the output from the reformer into a low temperature shift converter prior to entering the anode.

In an embodiment having one or more features of the method of any of the previous paragraphs, the output from the anode is only directed into the CO₂ capture system.

In an embodiment having one or more features of the method of any of the previous paragraphs, the method includes fueling a burner for the reformer with natural gas.

In an embodiment having one or more features of the method of any of the previous paragraphs, the method includes capturing CO₂ using the CO₂ capture system and directing an output from the CO₂ capture system comprising mostly hydrogen to a burner for the reformer.

In an embodiment having one or more features of the method of any of the previous paragraphs, the output from the anode is directed into a separating system to separate out a hydrogen stream prior to entering the CO₂ capture system.

In an embodiment having one or more features of the method of any of the previous paragraphs, the method includes directing the hydrogen stream into a burner for the reformer.

In an embodiment having one or more features of the method of any of the previous paragraphs, the method includes providing the hydrogen stream as a first output for the fuel cell power plant, and wherein the fuel cell power plant provides electricity as a second output, heat as a third output, and CO₂ as a fourth output.

In an embodiment having one or more features of the method of any of the previous paragraphs, the method includes separating the output from the anode into a first output to a burner for the reformer and a second output to the separating system.

An illustrative example embodiment of a system includes: a fuel cell power plant including a reformer that is supplied with natural gas; and a CO₂ capture system that captures CO₂ from an output of the reformer.

In an embodiment having one or more features of the system of any of the previous paragraphs, the fuel cell power plant includes: a burner that heats the reformer; a low temperature shift converter receiving the output of the reformer; and a fuel cell anode receiving an output of the low temperature shift converter, and wherein a exhaust output from the fuel cell anode is directed into the CO₂ capture system.

In an embodiment having one or more features of the system of any of the previous paragraphs, the exhaust output from the fuel cell anode is only directed into the CO₂ capture system.

In an embodiment having one or more features of the system of any of the previous paragraphs, the burner is only fueled using the natural gas.

In an embodiment having one or more features of the system of any of the previous paragraphs, the CO₂ capture system captures CO₂ and provides an output comprising mostly hydrogen to the burner.

In an embodiment having one or more features of the system of any of the previous paragraphs, the exhaust output from the fuel cell anode is directed into a separating system to separate out a hydrogen stream prior to entering the CO₂ capture system.

In an embodiment having one or more features of the system of any of the previous paragraphs, the hydrogen stream is directed into the burner.

In an embodiment having one or more features of the system of any of the previous paragraphs, the hydrogen stream comprises a first output for the fuel cell power plant, and wherein the fuel cell power plant provides electricity as a second output, heat as a third output, and CO₂ as a fourth output.

In an embodiment having one or more features of the system of any of the previous paragraphs, the exhaust output from the fuel cell anode is separated into a first output to the burner and a second output to the separating system.

In an embodiment having one or more features of the system of any of the previous paragraphs, the system further includes a control system that balances the exhaust output from the fuel cell anode between the first output and the second output to ensure sufficient fuel is provided to the burner to operate the reformer.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an example fuel cell power plant.

FIG. 2 schematically illustrates one example of a carbon capture system for a power plant.

FIG. 3 schematically illustrates another example of a carbon capture system for a power plant.

FIG. 4 schematically illustrates another example of a carbon capture system for a power plant.

FIG. 5 schematically illustrates another example of a fuel cell power plant with a carbon capture system.

### DETAILED DESCRIPTION

Embodiments of this disclosure relate to a method and system that uses different fuel cell power plant configurations that are implemented to provide a more CO₂ rich stream to a carbon capture system while still supplying enough heat to support the SMR reaction.

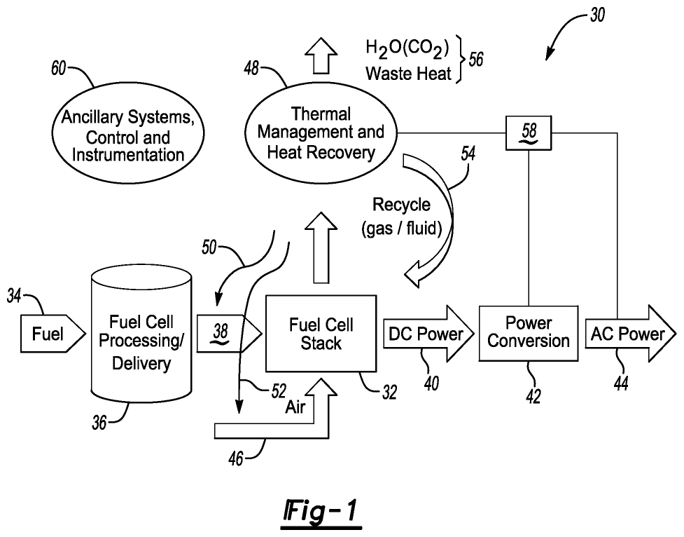

FIG. 1 schematically illustrates selected portions of an example fuel cell power plant 30 that is used to produce electrical power. A cell stack assembly (CSA) 32 includes a plurality of fuel cells that generate electrical power based on an electrochemical reaction. The fuel cells may take a variety of forms. For example, some fuel cells will be phosphoric acid fuel cells (PAFCs) while others will be polymer electrolyte membrane fuel cells (PEMs). Those skilled in the art who have the benefit of this description will be able to select an appropriate type of fuel cell and CSA arrangement to meet their particular needs.

In one example, fuel 34 is sent to a fuel cell processing and delivery system 36 that feeds into the CSA 32 as indicated at 38. The CSA 32 generates DC power 40 that is communicated to a power conversion system 42, e.g. inverters, where DC electrical power from the CSA 32 is converted into AC power 44 to be provided to a load external to the fuel cell power plant 30. Air 46 is supplied to the CSA 32 and a thermal management and heat recovery system 48 is used to thermally manage the fuel cell feed 38, the air supply 46, and the CSA 32 as respectively indicated by arrows 50, 52, 54. Output from the thermal management and heat recovery system 48 includes waste heat and H₂O(CO₂) as shown at 56.

One or more controllers 58 are part of a control system that controls operation of the power conversion system 42 to achieve a desired operation and output from the fuel cell power plant 30. The controller 58 also controls the thermal management and heat recovery system 48 and AC power output 44. The fuel cell power plant 30 also includes additional ancillary systems and instrumentation 60 as needed for operation of the fuel cell power plant 30. It should be understood that this is just one example of a fuel cell power plant 30 and other configurations could also be used.

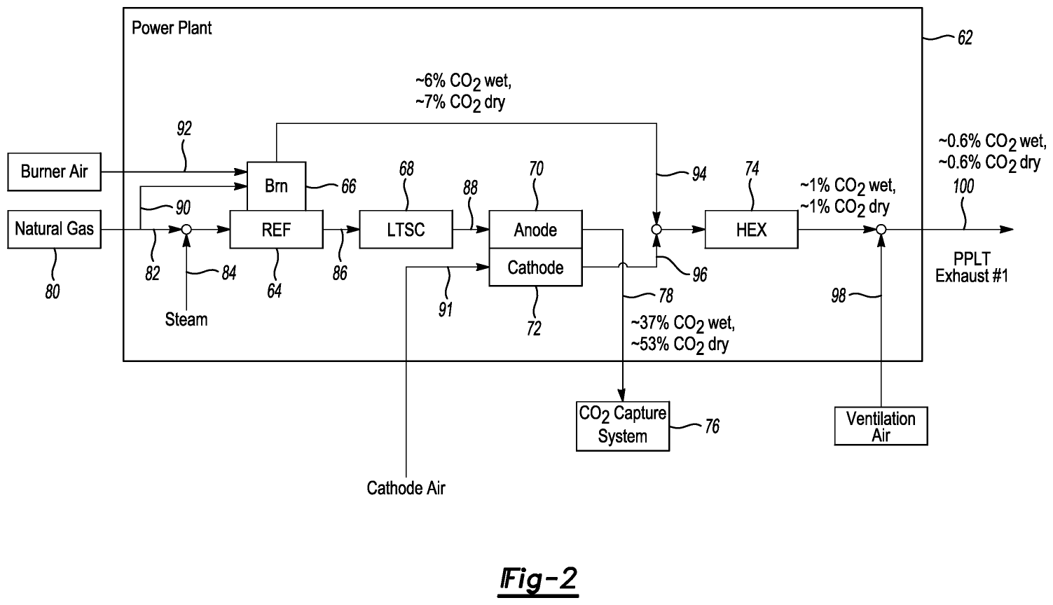

FIG. 2 schematically illustrates selected portions of an example fuel cell power plant 62 as used for capturing CO₂ according to one aspect of the disclosure. In this example, the fuel cell power plant 62 includes at least a reformer 64, a burner 66, a Low Temperature Shift Converter (LTSC) 68, a fuel cell anode 70, a fuel cell cathode 72, and a heat exchanger 74. In this example, anode exhaust is fed directly to a CO₂ capture system 76 as indicated at 78.

As shown in FIG. 2, a supply of raw natural gas 80 is fed into the reformer 64 (as indicated at 82) and steam 84 is fed into the reformer 64 to produce a hydrogen rich steam via Steam Methane Reforming (SMR). The supply of natural gas 80 is to be burned to provide the necessary heat for the SMR reaction. An output 86 of the reformer 64 is delivered to the LTSC 68, where a water-gas shift reaction (WGSR) occurs to form additional hydrogen and convert much of the CO formed in the reformer 64 to carbon dioxide. The water-gas shift reaction (WGSR) describes the reaction of carbon monoxide and water vapor to form carbon dioxide and hydrogen: CO+H₂O [symbol] CO₂+H₂. An output 88 from the LTSC 68 is delivered to the anode 70, with the exhaust from the anode 70 being fed directly to the CO₂ capture system 76 as indicated at 78.

A supply of natural gas 80 (as indicated at 90) and burner air (as indicated at 92) are delivered to the burner 66. Cathode air is an input to the cathode 72 as indicated at 91. The output 94 of the burner 66 (stream of N₂, O₂, H₂O, and CO₂) is combined with air 96 from an exhaust of the cathode 72 and is delivered to the heat exchanger 74. The outlet of the heat exchanger 74 is mixed with ventilation air 98 and forms a power plant exhaust stream 100. The combination of heat exchanger (condenser) exhaust and ventilation air exiting the power plant 62 in this configuration is only about 0.6% CO₂.

The configuration of FIG. 2 is simple but results in a lower efficiency than a baseline power plant because additional natural gas is sent to the burner 66 to provide necessary heat for reformer 64. Additionally, the CO₂ capture system 76 will most likely require additional energy to perform the separation. Further, the configuration of FIG. 2, while reducing the percentage of CO₂, e.g. 3% v. 0.6%, still has a small amount of CO₂ that is emitted to atmosphere via the power plant exhaust output stream 100.

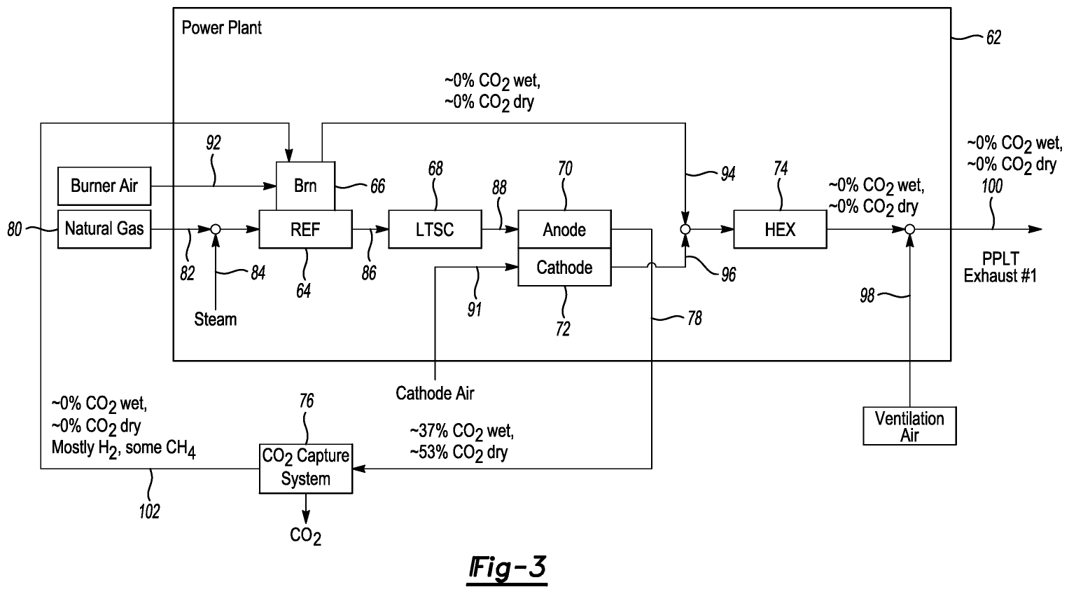

The efficiency lost in the configuration of FIG. 2 can be regained (excluding energy required by CO₂ capture system) by sending the output of the CO₂ capture system back to the reformer burner 66 as shown in the configuration of FIG. 3. FIG. 3 is similar to FIG. 2 in that a supply of raw natural gas 80 (as indicated at 82) and steam 84 are fed into the reformer 64. The output 86 of the reformer 64 is delivered to the LTSC 68. The output 88 from the LTSC 68 is delivered to the anode 70, with the exhaust from the anode 70 being fed directly to the CO₂ capture system 76 as indicated at 78.

However, in this example, natural gas is not delivered directly to the burner 66. Instead, burner air (as indicated at 92) and an output 102 from the CO₂ capture system 76 are delivered to the burner 66. The output 94 of the burner 66 is combined with air 96 from the cathode 72 and is delivered to the heat exchanger 74. The outlet of the heat exchanger 74 is mixed with ventilation air 98 and forms a power plant exhaust stream 100. The combination of heat exchanger (condenser) exhaust and ventilation air exiting the power plant 62 in this configuration has about 0% CO₂.

Thus, in this configuration an output 102 of the CO₂ capture system is directed back to the reformer burner 66. This output stream will be mostly hydrogen. In one example, the stream out of the CO₂ capture system will be ˜90% H₂ once CO₂ and H₂O are removed. The configuration of FIG. 3 significantly limits the CO₂ exhausted by the power plant 30. However, the configuration of FIG. 3 is more complicated than that of FIG. 2, particularly for systems that combine the anode exhaust of multiple power plants before delivering to a common CO₂ capture system. Depending upon the CO₂ capture technology, it may be a challenge to meet the requirements of the power plant return stream (in terms of temperature, pressure, and contaminant level) for this configuration.

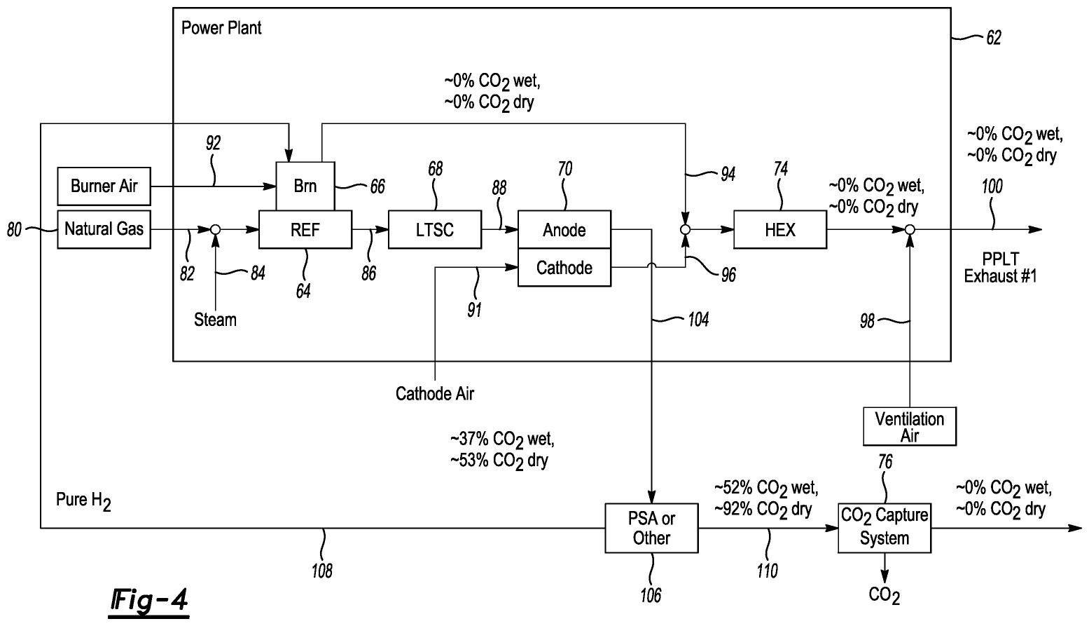

FIG. 4 shows an example configuration that improves over the configuration in FIG. 3. In the configuration of FIG. 4, the hydrogen is separated out prior to delivery to CO₂ capture system 76, and that pure hydrogen is delivered back to the burner 36. FIG. 4 is similar to FIG. 3 in that a supply of raw natural gas 80 (as indicated at 82) and steam 84 are fed into the reformer 64. The output 86 of the reformer 64 is delivered to the LTSC 68. The output 88 from the LTSC 68 is delivered to the anode 70.

However, in this example, the exhaust output 104 from the anode 70 is fed into a separating system 106 before being sent to the CO₂ capture system 76. The separating system 106 is a pressure swing adsorption (PSA) system, or other similar system, which is used to separate a gas species from a mixture of gases under pressure according to the species' molecular characteristics and affinity for an adsorbent material. In this example, the separating system 106 separates hydrogen from the exhaust output 104 from the anode 70, and this “pure” hydrogen is returned back to the burner 66 as indicated at 108. A non-hydrogen output 110 from the separating system 106 is then directed to the CO₂ capture system 76.

Thus, in this configuration, the burner air (as indicated at 92) and the hydrogen output 108 from the separating system 106 are delivered to the burner 66. The output 94 of the burner 66 is combined with air 96 from the cathode 72 and is delivered to the heat exchanger 74. The outlet of the heat exchanger 74 is mixed with ventilation air 98 and forms the power plant exhaust stream 100. The combination of heat exchanger (condenser) exhaust and ventilation air exiting the power plant 62 in this configuration has about 0% CO₂.

The CO₂ capture will be easier and cheaper with the configuration of FIG. 4 than with the configuration of FIG. 3 due to an even higher CO₂ volume fraction being fed to the CO₂ capture system 76. Further, in another contemplated configuration of FIG. 4, an outlet of the separating system 106 can be used as an energy input required for the CO₂ capture system 76.

The operation of CO₂ capture systems 76 is known. Any type of existing CO₂ capture system 76 can be used in the examples described above. Those skilled in the art who have the benefit of this description will be able to select an appropriate type of CO₂ capture system 76 to meet their particular needs. Additionally, it should be noted that each configuration will require a pressure booster (not shown) to ensure proper anode flows/pressures are maintained upon additional backpressure from CO₂ capture equipment of the CO₂ capture system 76.

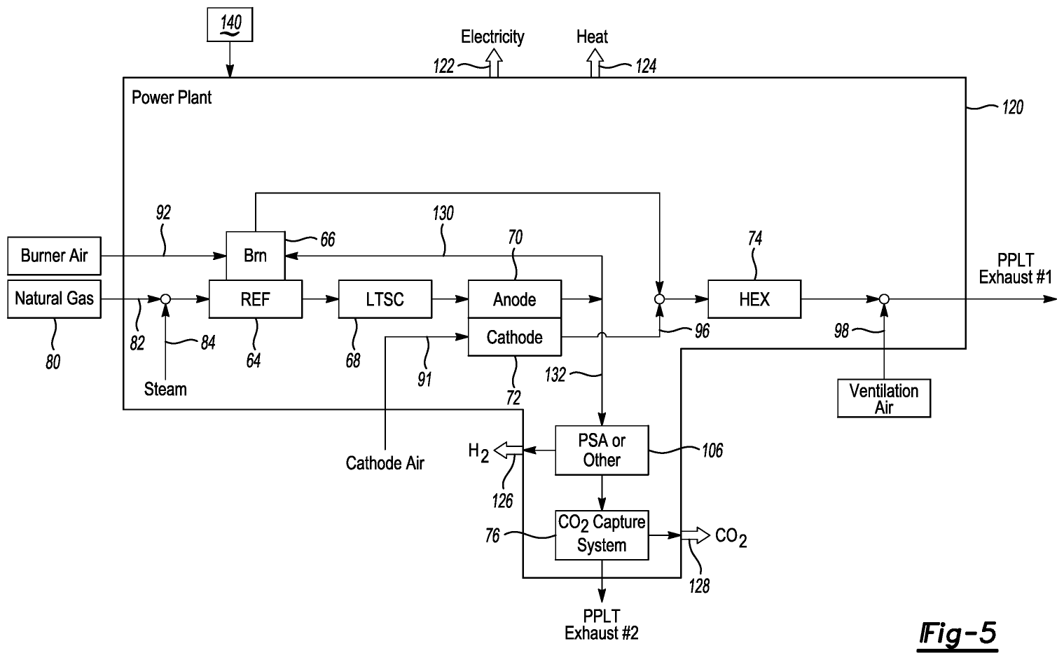

Each of the examples discussed above can comprise a fuel cell power plant system 120 that delivers electricity 122, heat 124, hydrogen 126, and carbon dioxide 128 as shown in FIG. 5. If the hydrogen 126 is not to be returned to the burner 66 and is instead used for other purposes, e.g. hydrogen charging stations, additional fuel will be needed for the burner 66. In one example, there is an alternate operating mode where the hydrogen delivered to the anode is split into two functions: (1) produce electricity and (2) provide hydrogen to the customer (for applications like fueling stations). While option (1) is a primary operating mode, option (2) is an alternate operating mode, and in one disclosed embodiment, CO₂ capture is added to operating mode (2).

In this example system 120, exhaust output from the anode 70 can be split into a first output 130 to the burner 66 and a second output 132 to the separating system 106 and/or the CO₂ capture system 76. A control system 140 (FIG. 5) using one or more controllers 58 (FIG. 1) is provided to control a balance between the two outputs 130, 132 such that there is enough fuel for the burner 66 to operate as intended.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method comprising:
fueling a reformer in a fuel cell power plant with natural gas; and
directing an output from the reformer into a CO₂ capture system.

2. The method according to claim 1, including directing the output from the reformer into an anode prior to entering the CO₂ capture system.

3. The method according to claim 2, including directing the output from the reformer into a low temperature shift converter prior to entering the anode.

4. The method according to claim 2, wherein the output from the anode is only directed into the CO₂ capture system.

5. The method according to claim 4, including fueling a burner for the reformer with natural gas.

6. The method according to claim 4, including capturing CO₂ using the CO₂ capture system and directing an output from the CO₂ capture system comprising mostly hydrogen to a burner for the reformer.

7. The method according to claim 2, wherein the output from the anode is directed into a separating system to separate out a hydrogen stream prior to entering the CO₂ capture system.

8. The method according to claim 7, including directing the hydrogen stream into a burner for the reformer.

9. The method according to claim 7, including providing the hydrogen stream as a first output for the fuel cell power plant, and wherein the fuel cell power plant provides electricity as a second output, heat as a third output, and CO₂ as a fourth output.

10. The method according to claim 9, including separating the output from the anode into a first output to a burner for the reformer and a second output to the separating system.

11. A system comprising:
a fuel cell power plant including a reformer that is supplied with natural gas; and
a CO₂ capture system that captures CO₂ from an output of the reformer.

12. The system according to claim 11, wherein the fuel cell power plant includes:
a burner that heats the reformer;
a low temperature shift converter receiving the output of the reformer; and
a fuel cell anode receiving an output of the low temperature shift converter, and wherein a exhaust output from the fuel cell anode is directed into the CO₂ capture system.

13. The system according to claim 12, wherein the exhaust output from the fuel cell anode is only directed into the CO₂ capture system.

14. The system according to claim 13, wherein the burner is only fueled using the natural gas.

15. The system according to claim 13, wherein the CO₂ capture system captures CO₂ and provides an output comprising mostly hydrogen to the burner.

16. The system according to claim 12, wherein the exhaust output from the fuel cell anode is directed into a separating system to separate out a hydrogen stream prior to entering the CO₂ capture system.

17. The system according to claim 16, wherein the hydrogen stream is directed into the burner.

18. The system according to claim 16, wherein the hydrogen stream comprises a first output for the fuel cell power plant, and wherein the fuel cell power plant provides electricity as a second output, heat as a third output, and CO₂ as a fourth output.

19. The system according to claim 18, wherein the exhaust output from the fuel cell anode is separated into a first output to the burner and a second output to the separating system.

20. The system according to claim 18, including a control system that balances the exhaust output from the fuel cell anode between the first output and the second output to ensure sufficient fuel is provided to the burner to operate the reformer.
